(19) United States
(12) Patent Application Publication
(10) Pub. No.: US 2013/0128580 A1
(43) Pub. Date: May 23, 2013

(54) HYBRID MULTIDIRECTIONAL LIGHT FIXTURE SYSTEM

(71) Applicant: Mike Olen NEVINS, Jackson, MI (US)

(72) Inventor: Mike Olen NEVINS, Jackson, MI (US)

(21) Appl. No.: 13/304,148

(22) Filed: Nov. 23, 2011

(51) Int. Cl. F21S 4/00

(52) U.S. Cl. 362/249.01

(57) ABSTRACT

A multidirectional lighting fixture system, comprising: a body having a vertical axis; a first illuminant affixed to the body to project a first flux, the first illuminant positioned on the body to project the first flux within a first area, wherein the first area extends from the first illuminant along the vertical axis and radially about the vertical axis to about 70 degrees; at least one secondary illuminant affixed to the body to project a second flux, the secondary illuminant positioned on the body to project the second flux within a second area, wherein the second area extends from about 60 degrees from the vertical axis to less than 90 degrees elevation from the vertical axis in a radial direction,

### BACKGROUND

Single source lighting fixtures are often mounted on poles or other structures and arranged to illuminate roadways, parking areas, and/or other lighting areas. Types of lighting fixtures include cobra head, shoebox, garage, and wall-mount. Cut-off and full cut-off lighting fixtures have been introduced to limit sky pollution by limiting the distribution of flux, i.e., amount of light emitted by a light fixture.

If the light distribution of mounted fixtures is shaped such that the light from one fixture does not adequately overlap or meet up with the next fixture, the cumulative light levels will not be uniform, but rather modulated such that dark spaces are found between fixture illuminated areas. Poor optical distribution between lighting fixtures also contributes to modulation of illuminance.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a front view of a hybrid multidirectional light fixture system according to an embodiment;

FIG. 2a is a left side view of an optical head of the hybrid multidirectional light fixture system according to an embodiment;

FIG. 2b is a right side view of an optical head of the hybrid multidirectional light fixture system according to an embodiment;

FIG. 3a is a left side view of an optical head of the hybrid multidirectional light fixture system according to an embodiment;

FIG. 3b is a right side view of an optical head of the hybrid multidirectional light fixture system according to an embodiment;

FIG. 4a is a side view of an optical head of the hybrid multidirectional light fixture system according to an embodiment;

FIG. 4b is a side view of an optical head of the hybrid multidirectional light fixture system according to an embodiment;

FIG. 5 is a top view of an optical head of the hybrid multidirectional light fixture system according to an embodiment;

FIG. 6 is a distant view of multiple hybrid multidirectional light fixture spaced to illuminate an area;

FIGS. 7-11 are views of lighting distribution according to one or more embodiments; and

FIG. 12 is a graph of lighting distribution according to an embodiment.

### DETAILED DESCRIPTION

One or more embodiments of a hybrid multidirectional light fixture system for roadway, parking, and other related lighting areas uses an advanced dual distribution characteristic for enhanced luminance distribution to reduce the modulation of illuminance between mounting locations, e.g., poles, and to increase evenness of flux distribution over an area. One or more embodiments of the hybrid multidirectional light fixture system utilize two different light sources, e.g., two or more different light source types, in combination to achieve an enhanced candela distribution that provides an improved spread or distribution of light while reducing artificial sky brightness, i.e., skyward directed lighting.

One or more embodiments of the hybrid multidirectional light fixture system 100 employ two separate illuminants to achieve an improved optical distribution characteristic over an area. The first illuminant 104 is designed for providing a primary flux contribution to the horizontal distribution from nadir around the first illuminant in approximately 50 to 70 degrees radially, depending upon the intended distribution type. The illumination generated is distributed over a conical volume defined by a base at ground level and the tip of the cone at the first illuminant. The angle of the cone at the tip is approximately 100-140 degrees, i.e., 50-70 degrees swept radially out from nadir or zero degrees downward toward the ground.

One or more embodiments of the hybrid multidirectional light fixture system 100 employ one or a series of secondary illuminants 106 connected with the light fixture to provide a highly directed flux that achieves a wider distribution than traditional light fixtures. In at least some embodiments, secondary illuminants 106 are integral to the system 100. In at least some embodiments, the hybrid multidirectional light fixture system 100 incorporates a secondary illuminant that provides flux from below 90° from nadir to reduce upward flux component directed skyward. In at least some embodiments, advanced LED lighting with a specified angular distribution characteristic comprises the secondary illuminant.

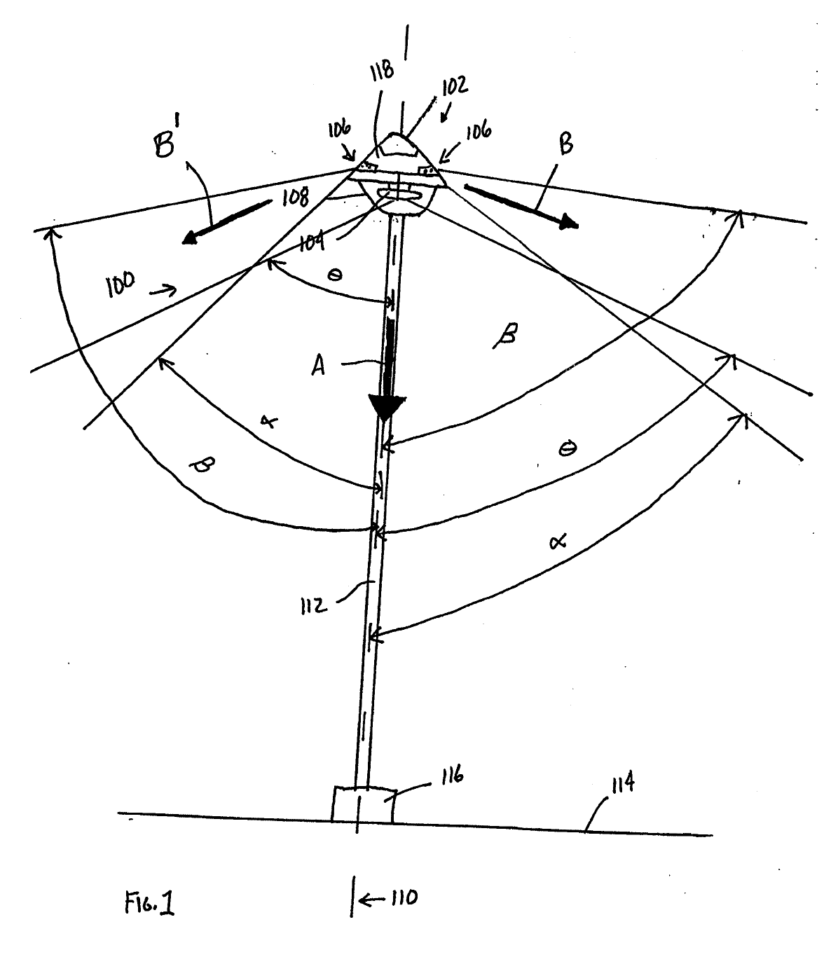

FIG. 1 is a front view of an embodiment of the hybrid multidirectional light fixture system 100 comprising an optical head 102. Incorporated within optical head 102 is first illuminant 104 that projects flux in a direction downward A and sweeping out up to an angle θ from A and distributed radially around a vertical axis 110 to illuminate an area having a generally conical shape. In at least some embodiments, vertical axis 110 is a central vertical axis perpendicular to the ground or area on which the flux is directed. In other embodiments, vertical axis 110 is positioned at a non-perpendicular angle to the ground depending on the desired lighting characteristic, coverage area and/or enhanced distribution type. In one embodiment, angle θ is 70 degrees. In other embodiments, angle θ ranges from 50 to 70 degrees. In still further embodiments, angle θ is less than 90 degrees.

A lens 108 is attached to the optical head 102 to encase first illuminant 104 therein. In at least some embodiments, lens 108 is transparent. In at least some other embodiments, lens 108 is at least partially transparent. In some embodiments, lens 108 is formed with first illuminant 104 as a single unit and attached to optical head 102.

In at least one embodiment, the set of secondary illuminants 106 are incorporated into optical head 102 on either side of vertical axis 110 and project flux generally along direction B and B′ between an elevation defined by angle α and angle β from vertical axis 110. Each set of secondary illuminants illuminate an area generally defined by the ground at one end and the secondary illuminant at the other end.

The contribution of flux in a horizontal direction due to the secondary illuminants 106 is dependent on the spacing of secondary illuminants about the hybrid multidirectional light fixture system 100. In one embodiment, a plurality of secondary illuminants are spaced equidistant about the hybrid multidirectional light fixture system 100 to project flux. In other embodiments, a plurality of secondary illuminants are spaced symmetrically or asymmetrically about the hybrid multidirectional light fixture system 100 to achieve a desired lighting characteristic and coverage area.

In at least some embodiments, the hybrid multidirectional light fixture system 100 achieves type V distributions (for example, as described according to the lighting distributions of the Illuminating Engineering Society (IES)) to extend the Candela distribution without contributing to sky brightness. In these embodiments, varied placement of the secondary illuminants generates asymmetric distributions where the flux is directed to solely a single side of the lighting pole.

In one embodiment, angle α is 60 degrees from vertical axis 110 and angle β is 80 degrees from vertical axis 110. In other embodiments, angle α ranges between 60 and 80 degrees and angle β ranges between 60 and less than 90 degrees. In at least some other embodiments, angle α is less than 60 degrees.

In at least one embodiment, the area illuminated by the first illuminant and the areas illuminated by the secondary illuminants overlap in the elevation between angles θ and α.

The hybrid multidirectional light fixture system 100 is installed on a surface 114 by way of a pedestal 116. In at least some embodiments, surface 114 comprises ground, roadway, or other supporting surface. In at least some embodiments, pedestal 116 comprises any of a number of supportive materials such as stone, concrete, metal, etc. In at least some embodiments, pedestal 116 is optional.

Hybrid multidirectional light fixture system 100 comprises a vertically extending support pole 112. In at least some embodiments, support pole 112 may extend horizontally or at a different angle in-between horizontal and vertical. In at least some embodiments, support pole 112 is hollow; however, in other embodiments different configurations may be possible. In at least some embodiments, support pole 112 may be comprised of metal, plastic, concrete and/or a composite material. In at least some further embodiments, support pole 112 may be optionally replaced by mounting light fixture system 100 directly to a support structure, e.g., wall, ceiling, etc.

Optical head 102 has a body 118 that is physically connected to support pole 112. In at least some embodiments, support pole 112 also provides a conduit through which electricity is supplied to the hybrid multidirectional light fixture system 100 to illuminate the first and second illuminants. For example, a connection to a mains or other power source may be provided.

In at least one embodiment, first illuminant 104 is an induction based light source. An induction-based light source provides increased lifespan and/or reduces a required initial energy requirement for illumination. An induction-based light source does not use electrical connections through a lamp in order to transfer power to the lamp. Electrode-less lamps transfer power by means of electromagnetic fields in order to generate light. In an induction-based light source, an electric frequency generated from an electronic ballast is used to transfer electric power to an antenna coil within the lamp. In accordance with at least some embodiments, first illuminant 104 may have an increased lifespan with respect to other types, e.g., incandescent and/or florescent light sources having electrodes. In accordance with at least some embodiments, optical head 102 may have a reduced initial energy requirement for start up of the light source. In at least some embodiments, hybrid multidirectional light fixture system 100 receives power from a 24 volt power source for provision to optical head 102. In at least some other embodiments, hybrid multidirectional light fixture system 100 receives power from a mains power supply and converts the received power to a 24 volt power level for use by optical head 102.

In at least some embodiments, hybrid multidirectional light fixture system 100 is electrically connected, either directly or indirectly, to a power source. In at least some alternate embodiments, a plurality of first illuminants may be incorporated into the hybrid multidirectional light fixture system 100. In at least some embodiments, first illuminant 104 may be arranged to provide illumination in a directional manner, i.e., downward, upward, etc., with respect to an orientation of the light source. In at least some embodiments, hybrid multidirectional light fixture system 100 may comprise a plurality of first illuminants 104 arranged at differing elevations and/or at different angular spacing about support pole 112.

In at least some embodiments, optical head 102 comprises a controller for controlling activation and/or operation of the hybrid multidirectional light fixture system 100. In at least some other embodiments, optical head 102 comprises the controller integral thereto, e.g., attached to or within support pole 112, for controlling activation and/or operation of the light fixture.

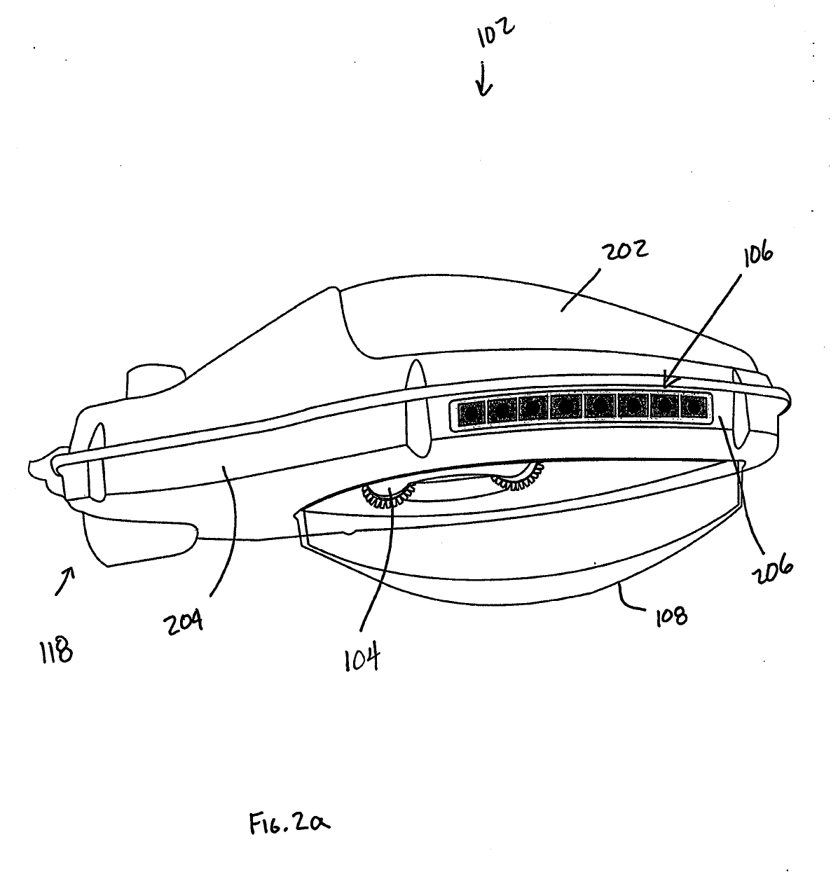

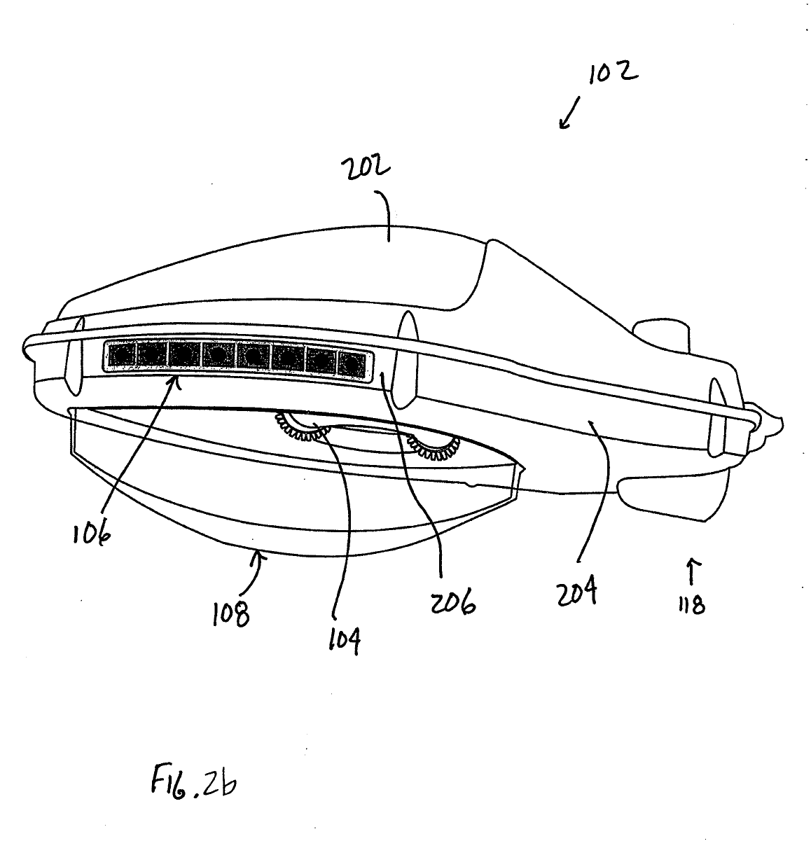

FIG. 2a depicts a left side view of the optical head 102 according to an embodiment of the hybrid multidirectional light fixture system 100. In at least some embodiments, optical head 102 is a cobra head light fixture. In other embodiments, optical head 102 is a shoebox, wall mount, garage or canopy type light fixture.

Optical head 102 comprises a body 118. The body 118 comprises a top cover 202, a lower cover 204, and lens 108 connected together. In at least some embodiments, top cover 202 is connected directly to at least lower cover 204. Lens 108 covers the first illuminant 104. In at least some embodiments, lens 108 is a drop-down lens that is segmented or flat-topped conical shape in form. In other embodiments, the lens 108 is a flat lens. In at least some embodiments, lens 108 is transparent. In at least some other embodiments, lens 108 is at least partially transparent.

In at least some embodiments, optical head 102 comprises a specular reflector optimized for induction lamp geometry. In at least some embodiments, lens 108 is an acrylic lens with Type III, medium throw prescription optics.

Top cover 202 and/or lower cover 204 may be constructed of a polycarbonate material. In at least some embodiments, top cover 202 is removably connected to lower cover 204. In at least some embodiments, lens 108 is removably connected to lower cover 204.

In at least one embodiment, first illuminant 104 is an induction-based light source, e.g., an induction-based light bulb, and directs the illumination provided by the light source from the hybrid multidirectional light fixture system 100. An induction-based light source provides increased lifespan and reduced energy requirement for illumination. In at least some embodiments, first illuminant 104 is electrically connected, either directly or indirectly, to a power source.

FIG. 2b is a right side view of the optical head 102 of FIG. 2a. A second set of illuminants, i.e., secondary illuminants 106 is integrated into the exterior surface 206 of bottom cover 204.

Optical head 102 comprises a plurality of secondary illuminants 106. In at least some embodiments, multiple sets of secondary illuminants 106 may be positioned about vertical axis 110 (FIG. 1). In other embodiments, a single secondary illuminant is utilized depending on the intensity and desired effects of the secondary illuminant. In at least some embodiments, secondary illuminants 106 are positioned and affixed to the exterior surface 206 of bottom cover 204.

In at least some embodiments, the secondary illuminant 106 is a light emitting diode (LED), which is powered using a current-regulated AC to DC converter. Additional embodiments involve different broad-spectrum lights and light sources, including induction, fluorescent, linear fluorescent, compact fluorescent, and other discharge lamps including both low or high pressure. In at least some embodiments, secondary illuminant 106 is electrically connected, either directly or indirectly, to a power source.

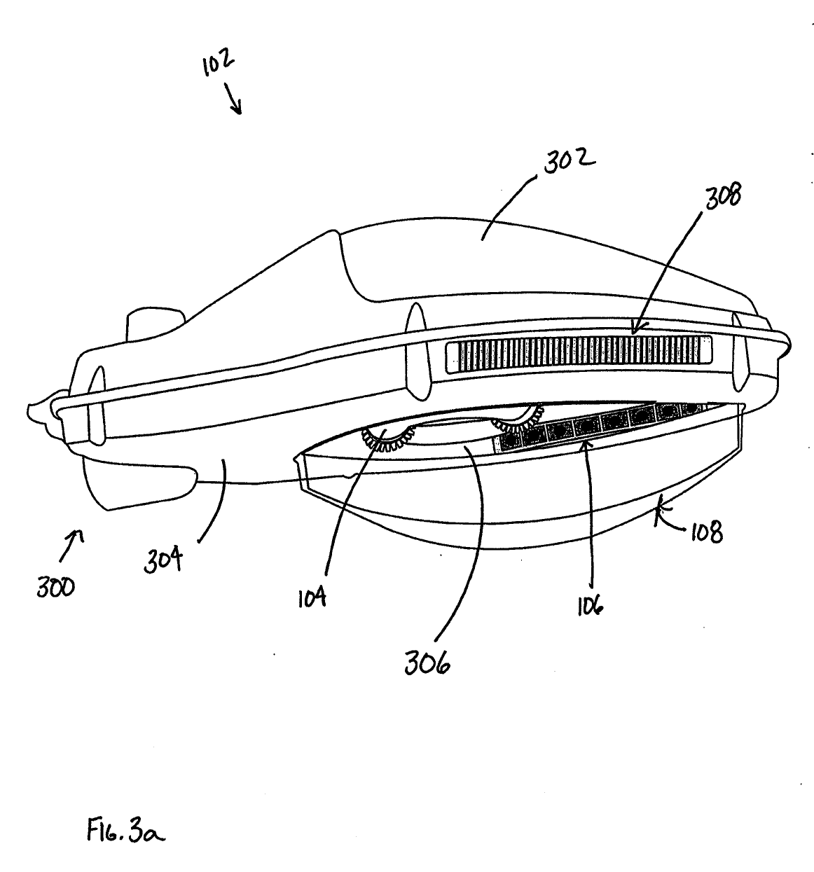

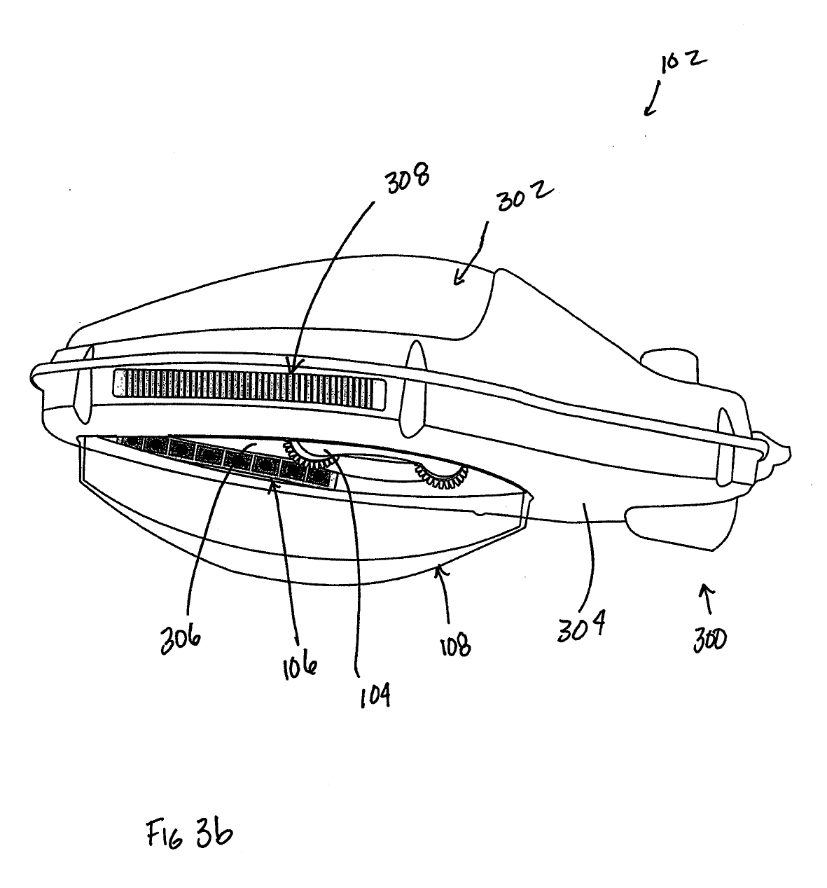

FIG. 3a depicts a left side view of another embodiment of the optical head 102 according to another embodiment of the hybrid multidirectional light fixture system 100. Optical head 102 comprises a body 300. Body 300 has a top cover 302, a lower cover 304, and a lens 108 connected together. In at least some embodiments, top cover 302 is connected directly to at least lower cover 304. Lens 108 covers a first illuminant 104, e.g., an induction-based light bulb, and directs the illumination provided by the hybrid multidirectional light fixture system 100.

In one embodiment, secondary illuminants 106 are formed on an interior surface 306 of lower cover 304. In at least one embodiment, secondary illuminants 106 are formed on an interior surface of the lower cover 304 about vertical axis 110 (FIG. 1) and are covered by lens 108. In other embodiments, multiple sets of secondary illuminants 106 may be positioned on optical head 102 about vertical axis 110 (FIG. 1). In other embodiments, a single secondary illuminant 106 is utilized depending on the intensity and desired effects of the secondary illuminant.

FIG. 3b is a right side view of the optical head 102 of FIG. 3a. A second set of secondary illuminants 306 is integrated into the exterior surface 306 of bottom cover 304.

In at least one embodiment, optical head 102 comprises a heat sink 308 integrated into the lower cover 304 and opposite secondary illuminants disposed on the interior surface 306 of the lower cover 304. In at least some embodiments, heat sink 308 is formed as an integrated portion of lower cover 304 and positioned on the exterior surface of bottom cover 304. In at least some embodiments, the integrated nature of heat sink 308 enables an extended system life. In other embodiments, heat sink 308 is positioned adjacent secondary illuminants 106, depending on the positioning of secondary illuminants 106 on the optical head 102.

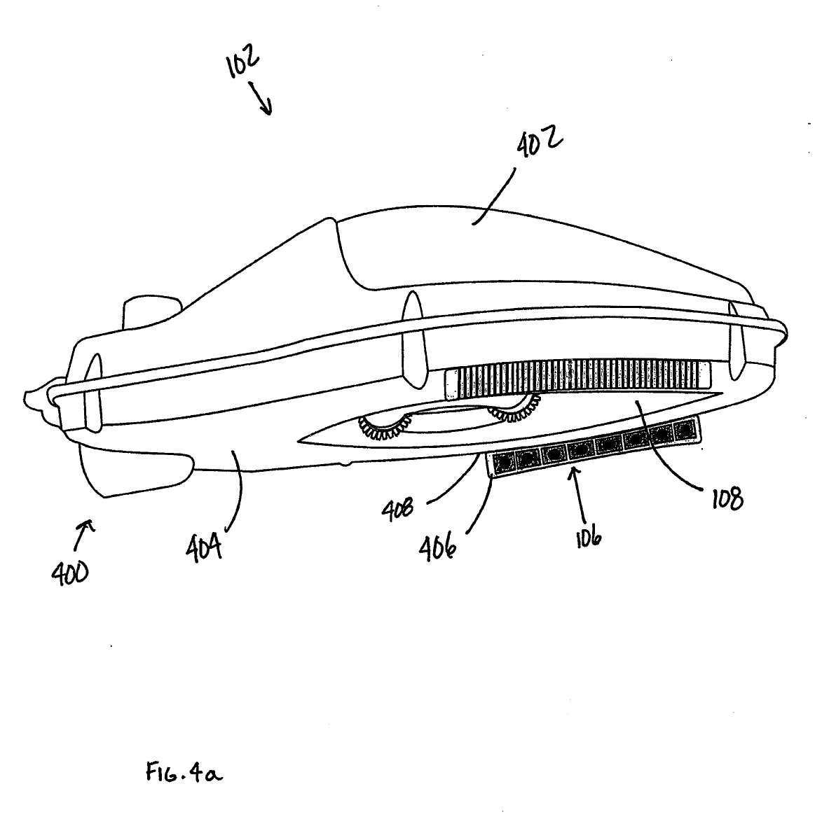

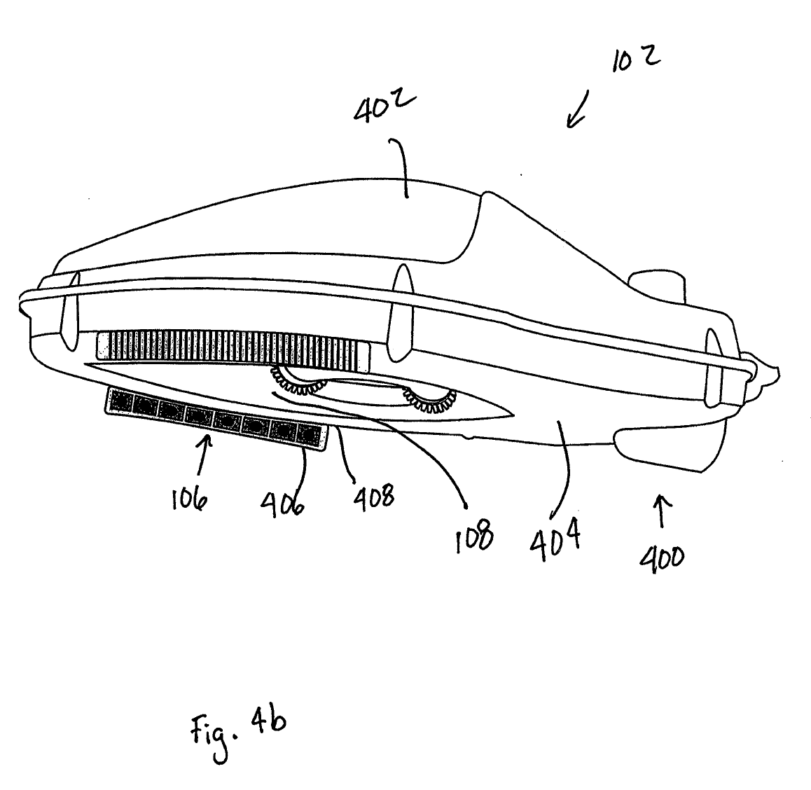

FIG. 4a depicts a left side view of another embodiment of an optical head 102 according to an embodiment of the hybrid multidirectional light fixture system 100. Optical head 102 comprises a body 400 having a top cover 402, a lower cover 404, and a lens 108 connected together.

In at least one embodiment, lens 108 is a flat lens. Lens 108 covers first illuminant 104.

In some embodiments, secondary illuminants 106 are housed within a casing 406. Casing 406 is formed on an exterior bottom surface of lower cover 404. In at least one embodiment, casing 406 is formed on the exterior surface 408 of bottom cover 404 about vertical axis 110 (FIG. 1). In other embodiments, multiple casings 406 housing one or more secondary illuminant 106 may be positioned on an optical head about vertical axis 110 (FIG. 1). In other embodiments, a single casing 406 housing a single secondary illuminant 106 is utilized depending on the intensity and desired effects of the secondary illuminant.

FIG. 4b is a right side view of the optical head 102 of FIG. 4a. A second set of secondary illuminants 106 are housed inside casing 406.

In at least some embodiments, heat sink 410 is formed as an integrated portion of casing 406. Heat sink 410 is positioned opposite the location of the secondary illuminants 106 formed in the casing 406. In at least some embodiments, the integrated nature of heat sink 410 enables an extended system life. In other embodiments, heat sink 410 is positioned adjacent secondary illuminants 106, depending on the positioning of secondary illuminants 106 on the optical head 102.

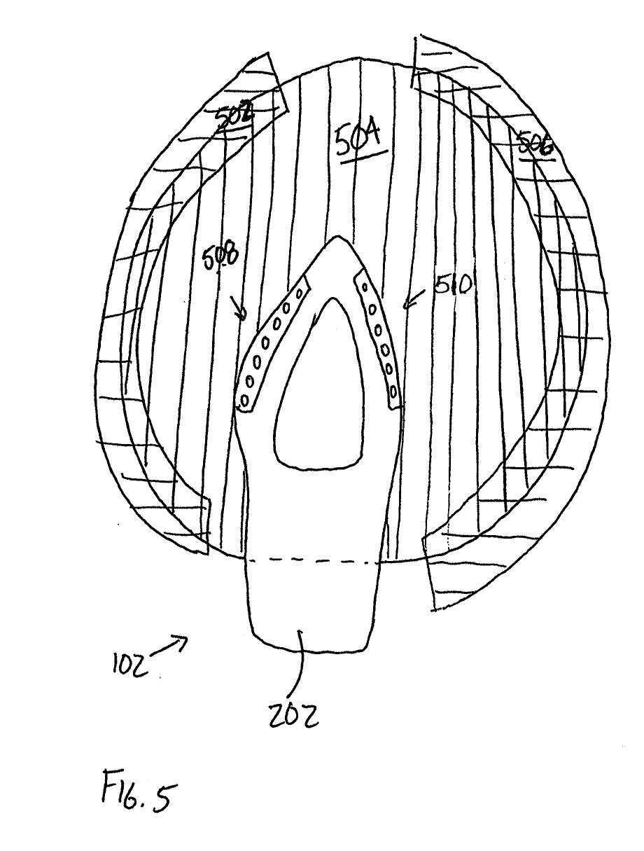

FIG. 5 is a top view of an embodiment of the hybrid multidirectional light fixture system 100 comprising the plurality of secondary illuminants. Secondary illuminants 508 are incorporated on the left facing portion of optical head 102 and secondary illuminants 510 are incorporated on the right facing portion of optical head 102.

Secondary illuminants 508 and 510 project flux between 60 and 80 degrees from vertical axis 110 (FIG. 1) and semi-circularly about the optical head 102 to illuminate areas 502 and 506, respectively. In at least some embodiments, secondary illuminants 106 extend around the entire circumference of light fixture system 100. First illuminant 104 (not shown in FIG. 5) projects flux over a conical volume defined by the tip at the first illuminant 104, surface 114 at the base, and radially about vertical axis 110 (FIG. 1) between 50 and 70 degrees to illuminate an area 504. Area 502 and area 504 intersect, and area 506 and 504 intersect, to increase evenness of flux distribution over the entire coverage area and to decrease modulation of illuminance between multiple spaced light fixtures.

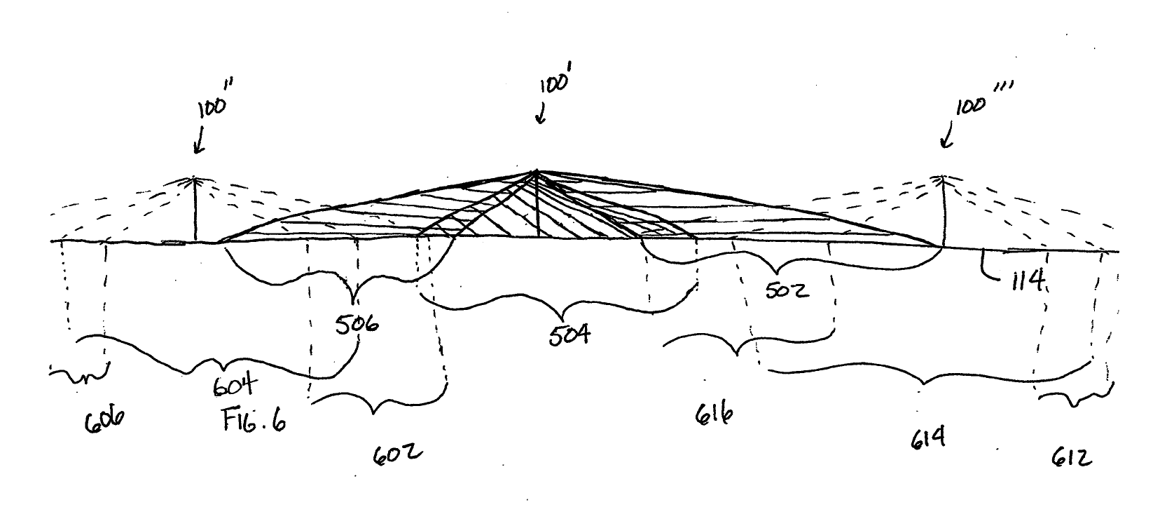

FIG. 6 is a distant view of multiple hybrid multidirectional light fixture systems 100 spaced along a surface 114 to provide illumination below the horizon and decrease modulation of illumination between lighting fixtures, while decreasing artificial sky brightness. Hybrid multidirectional light fixture system 100′ illuminates areas 502 and 506 by the secondary illuminants 106 (not shown). Hybrid multidirectional light fixture system 100′ illuminates area 504 by the first illuminant 104 (not shown).

Hybrid multidirectional light fixture system 100″ illuminates areas 602 and 606 by the secondary illuminants 106 (not shown). Hybrid multidirectional light fixture system 100″ illuminates area 604 by the first illuminant 104 (not shown).

Hybrid multidirectional light fixture system 100′″ illuminates area 612 and 616 by the secondary illuminants 106 (not shown). Hybrid multidirectional light fixture system 100′″ illuminates area 614 by the first illuminant 104 (not shown).

At least illuminated areas 502 and 616 intersect to decrease modulation of illumination between light fixture systems 100′ and 100′″. Similarly, at least illuminated areas 506 and 602 intersect to decrease modulation of illumination between light fixture systems 100′ and 100″. The illuminated intersected areas have a cumulative effect and decreases modulation of illuminance along the outer edges of the illuminated areas.

In at least some embodiments, the hybrid multidirectional light fixture system 100 has secondary illuminants appropriately arranged around the light fixture to achieve multiple enhanced distribution types. For example, secondary illuminants positioned on two opposing sides of the first illuminant 104 achieve an enhanced and wider distribution characteristic for type I, II, III and IV roadway distributions than traditional light fixtures. A first illuminant 104 provides the main flux for the distribution and the secondary illuminant extends flux angularly outward to reduce modulation between light fixture heads.

In some embodiments, secondary illuminants 106 are arranged about the fixture in varying configurations to create multiple enhanced distribution types.

For example, in at least some embodiments, secondary illuminants 106 are positioned on opposing sides of the hybrid multidirectional light fixture system to achieve type I, type II, or type III distributions.

Type I, II, III, and V light distributions are IESNA (Illuminating Engineering Society of North America) defined shapes intended for different exterior lighting applications (tunnels, freeways, parking lots, parking garages, etc.). They range from very elliptical in pattern (Type I) to circular or square (Type V).

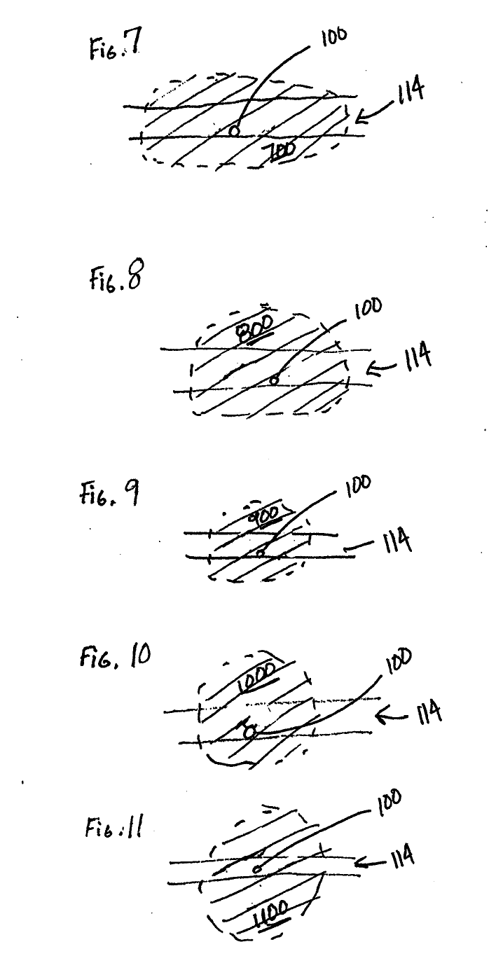

FIG. 7 depicts a type I roadway distribution. To achieve type I distribution, a light fixture 100 is positioned at or near the center of a surface 114, or a pathway. Light fixture 100 directs flux over an area 700, defined by the cumulative illumination by the first illuminant 104 (not shown) and the secondary illuminants 106 (not shown). In a type I distribution, multiple light fixtures are spaced area approximately two mounting heights in width. Type I distribution is ideal for narrow walkways or bike paths.

FIG. 8 depicts a type II roadway distribution. To achieve type II distribution, a light fixture 100 is positioned at or near the side of a surface 114, or a roadway. Light fixture 100 directs flux over an area 800, defined by the cumulative illumination by the first illuminant 104 (not shown) and the secondary illuminants 106 (not shown). In a type II distribution, multiple light fixtures are spaced approximately two mounting heights in width. Type II distribution is ideal for wider walkways, entrance roadways, bike paths and other long and narrow lighting applications.

FIG. 9 depicts a type III roadway distribution. To achieve Type III distribution, a light fixture 100 is positioned at or near the side of a surface 114, or the illuminated area. Light fixture 100 directs flux over an area 900, defined by the cumulative illumination by the first illuminant 104 (not shown) and the secondary illuminants 106 (not shown). In a type III distribution, multiple light fixtures are spaced approximately 2.75 mounting heights in width. Type III distribution is ideal for roadway, general parking, and other area lighting applications.

FIG. 10 depicts a type IV roadway distribution. To achieve Type IV distribution, a light fixture 100 is positioned near the side of the surface 114, or illuminated area. Light fixture 100 directs flux over a semicircular area 1000, defined by the cumulative illumination by the first illuminant 104 (not shown) and the secondary illuminants 106 (not shown). In a type IV distribution, multiple light fixtures are spaced approximately 2.75 mounting heights in width. To achieve Type IV distribution, a light fixture is typically wall mounted or mounted on the perimeter of an area.

FIG. 11 depicts a type V roadway distribution. A distribution is classified as type V when it has a circular symmetry lighting area 1100, defined by the cumulative illumination by the first illuminant 104 (not shown) and the secondary illuminants 106 (not shown). Lighting area 1100 is essentially the same at all lateral angles around the hybrid multidirectional light fixture system.

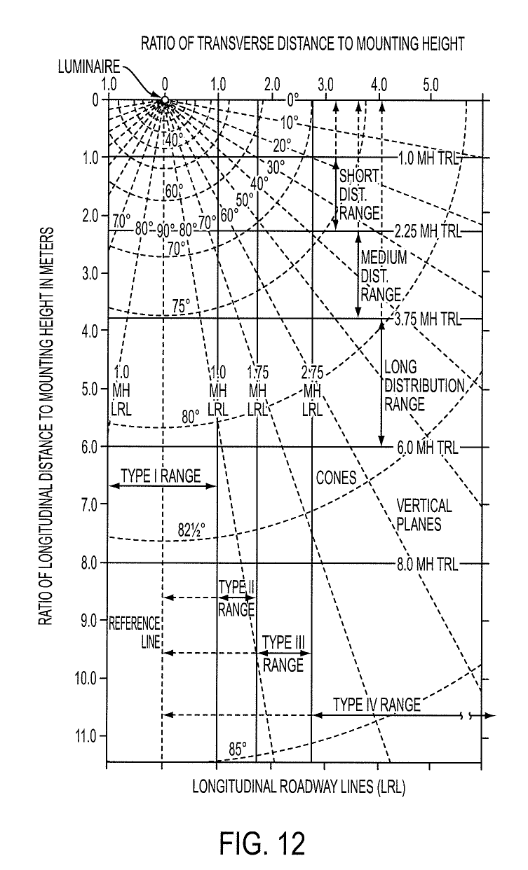

Luminaire light distribution is classified on the basis of an isointensity trace superimposed on a grid of longitudinal and transverse roadway lines in multiples of mounting height. IESNA Lighting Handbook© 2000 (9th Edition). FIG. 12 is a chart from IESNA Lighting Handbook© 2000 (9th Edition) defining each distribution type along with a generalized distribution shape.

Spacing between light fixtures is a consideration when determining, the proper illumination of an intended area. Vertical light distributions are characterized as short, medium or long.

Short distribution is when the maximum-intensity point lies between the 1.0 mounting height transverse roadway line up to the 2.25 mounting height transverse roadway line (FIG. 12). Maximum luminaire spacing is generally <4.5 times the mounting height.

Medium distribution is when the maximum-intensity point lies between the 2.25 mounting height transverse roadway line up to the 3.75 mounting height transverse roadway line (FIG. 12). Maximum luminaire spacing is generally <7.5 times the mounting height.

Long distribution is when the maximum-intensity point lies between the 3.75 mounting height transverse roadway line up to the 6.00 mounting height transverse roadway line (FIG. 12). Maximum luminaire spacing is generally <12.0 times the mounting height.

In this case, the first illuminant 104 provides the main flux for type I, type II, type III, type IV or type V distribution. To reduce modulation of illuminance between multiple lighting fixtures, secondary illuminants 106 of the hybrid multidirectional light fixture 100 extend additional flux outwards. The hybrid multidirectional light fixture 100 described herein maintains as much flux as possible directed towards the horizontal but not above the horizontal limit sky pollution. Hybrid multidirectional light fixture 100 closely matches the need for optimal spread of light while reducing the potential for sky brightness. The hybrid multidirectional light fixture 100 ensures light levels between spaced light fixtures are uniform.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A multidirectional lighting fixture system, comprising:
a body having a vertical axis;
a first illuminant affixed to the body to project a first flux, the first illuminant positioned on the body to project the first flux within a first area, wherein the first area extends from the first illuminant along the vertical axis and radially about the vertical axis to about 70 degrees;
at least one secondary illuminant affixed to the body to project a second flux, the secondary illuminant positioned on the body to project the second flux within a second area, wherein the second area extends from about 60 degrees from the vertical axis to less than 90 degrees elevation from the vertical axis in a radial direction,
wherein the first illuminant and the secondary illuminant comprise different light sources.

2. The multidirectional lighting fixture system as claimed in claim 1, wherein the first illuminant is an induction based light source.

3. The multidirectional lighting fixture system as claimed in claim 1, wherein the secondary illuminant is an LED based light source.

4. The multidirectional lighting fixture system as claimed in claim 1, further comprising a plurality of secondary illuminants distributed uniformly about the vertical axis.

5. The multidirectional lighting fixture system as claimed in claim 1, wherein the secondary illuminant is affixed to an exterior surface of the body.

6. The multidirectional lighting fixture system as claimed in claim 1, wherein the secondary illuminant is affixed to an interior surface of the body.

7. A multidirectional lighting fixture system, comprising:
a body having a vertical axis;
a first illuminant affixed to the body to project a first flux into a first conical volume defined by the vertical axis outwardly to about 70 degrees in a radial direction; and
at least one secondary illuminant affixed to the body to project a second flux into a second conical volume defined by about 60 degrees from the center vertical axis to just below 90 degrees from the center vertical axis in a radial direction, the first illuminant and the secondary illuminant comprise different light sources.

8. The multidirectional lighting fixture system as claimed in claim 7, wherein the first illuminant is an induction based light source.

9. The multidirectional lighting fixture system as claimed in claim 7, wherein the secondary illuminant is an LED based light source.

10. The multidirectional lighting fixture system as claimed in claim 7, further comprising a plurality of secondary illuminants positioned uniformly about the center vertical axis.

11. A multidirectional lighting fixture system, comprising:
a body having a vertical axis;
a means for projecting a first flux along a first area defined by the vertical axis to about 70 degrees in a radial direction; and
a means for projecting a second flux along a second area defined by about 60 degrees from the vertical axis to just below 90 degrees from the vertical axis in a radial direction, the means for projecting the first flux and the means for projecting the second flux having different means.

12. The multidirectional lighting fixture system as claimed in claim 11, wherein the means for projecting a first flux is an induction based light source.

13. The multidirectional lighting fixture system as claimed in claim 11, wherein the means for projecting a second flux is an LED based light source.

14. The multidirectional lighting fixture system as claimed in claim 11, further comprising a plurality of means for projecting a second flux along a second area.

15. A lighting fixture system, comprising:
a first light fixture having a body, a first illuminant affixed to the body, at least one secondary illuminant affixed to the body, the first illuminant and second illuminant illuminate a first area, and
a second light fixture having a body, a first illuminant affixed to the body, at least one secondary illuminant affixed to the body, the first illuminant and second illuminant illuminate a second area,
wherein the first area and second area intersect to decrease modulation of illumination between the first and second light fixture.

16. The lighting fixture system as claimed in claim 15, wherein the first illuminant and second illuminant of the first light fixture comprise different light sources.

17. The lighting fixture system as claimed in claim 16, wherein the first illuminant and second illuminant of the second light fixture comprise different light sources.

18. The multidirectional lighting fixture system as claimed in claim 16, wherein the first illuminant is an induction based light source.

19. The multidirectional lighting fixture system as claimed in claim 11, wherein the second illuminant is an LED based light source.
